(19) United States
(12) Patent Application Publication
(10) Pub. No.: US 2014/0112730 A1
(43) Pub. Date: Apr. 24, 2014

(54) PROFILE CUTTER

(71) Applicant: Apple Inc., Cupertino, CA (US)

(72) Inventors: Piotr S. Trzaskos, Saratoga, CA (US); Brian K. Copeland, San Jose, CA (US); Nathaniel H. Henderson, Cupertino, CA (US)

(21) Appl. No.: 13/910,025

(22) Filed: Jun. 4, 2013

Related U.S. Application Data
(60) Provisional application No. 61/716,371, filed on Oct. 19, 2012.

(51) Int. Cl. B23C 5/14; B23C 3/12; B23C 3/16

(52) U.S. Cl. CPC B23C 5/14; B23C 3/16; B23C 3/12
USPC 409/80; 409/132; 407/30

(57) ABSTRACT

The described embodiments relate generally to device housings and more particularly to methods for blending multiple surfaces of a device housing during a machining process. A method is disclosed that prevents the formation of steps and allows for a smooth transition between flat and curved surfaces by using a profile cutter with an obtuse angle. The profile cutter can extend into the area in which the flat surface is desired while angling upwards and away from the part. This angle can ensure that the boundary between the flat surfaces and curved surfaces forms a shallow peak rather than a step. A shallow peak can be relatively easier to blend during a polishing operation than a step. As a result, the boundaries between surfaces can be hidden from the user of the device and the manufacturing process can be more efficient.

### CROSS-REFERENCE TO RELATED APPLICATIONS

This application claims the benefit of U.S. Provisional Patent Application No. 61/716,371, filed Oct. 19, 2012 and entitled “PROFILE CUTTER” by TRZASKOS et al., which is incorporated by reference in its entirety for all purposes.

### FIELD OF THE DESCRIBED EMBODIMENTS

The described embodiments relate generally to device housings and more particularly to methods for blending multiple surfaces of a device housing during a machining process.

### BACKGROUND

The outward appearance of an electronic device can be important to a user of the device, as the outward appearance contributes to the overall impression that the user has of the device. Many devices are contained within an exterior housing that is made from one piece of material and can include multiple external surfaces. Often, this housing can include a front or back surface that is substantially flat and one or more side portions that are curved. When this is the case, the outward appearance of the device can be enhanced by ensuring that that the flat and curved surface of the exterior housing are blended together so that the user cannot distinguish one surface from another.

When the external housing is formed using a machining process, conventional machining methods can fail to adequately blend multiple surfaces together in an efficient manner suitable for use in a high volume manufacturing environment. Sometimes, a profile cutter is used around a periphery of a device housing to form a curved surface while a larger fly cutter is used to form the flat surface. Imperfections and tolerances in the part and the machining processes can result in a mismatch between the curved surface and the flat surface, resulting in a step. When the step exceeds approximately three microns in depth, the step can be visible to the user of the device. Moreover, conventional polishing techniques used to remove such steps can remove excessive amounts of material, resulting in parts that do not meet tolerances requirements. In addition, polishing away a step can cause a shallow groove to form in the surface that can also be visible to the user of the device.

Therefore, what is desired is an efficient method for blending a curved surface and a flat surface during a machining process associated with a high volume manufacturing operation.

### SUMMARY OF THE DESCRIBED EMBODIMENTS

Various embodiments are described herein that relate to methods for blending multiple surfaces of a device housing during a machining process.

According to one embodiment, a method for forming a device housing with curved side surfaces that blend into a flat back surface is disclosed. The method includes receiving a device housing material, machining the curved side surfaces along a periphery of the device housing using an obtuse profile cutter that includes a curved section configured to create the curved side surface and a straight angled portion configured to provide a transition from the curved side surfaces to the flat back surface, machining the flat back surface, and performing a polishing process on the intersection between the curved side surfaces and the flat back surface to remove any peaks and provide a seamless transition between the curved side surfaces and the flat back surface. The straight angled portion of the obtuse profile cutter can prevent the formation of a step between the curved side surfaces and the flat back surface that can be difficult to remove during a subsequent polishing operation.

According to another embodiment, a method for forming a device housing with curved side surfaces that blend into a flat back surface is described. The method includes receiving a device housing material, and machining the curved side surfaces along a periphery of the device housing material using an obtuse profile cutter. The obtuse profile cutter includes a curved section configured to create the curved side surfaces and a straight angled portion configured to provide a transition from the curved side surfaces to the flat back surface.

According to another embodiment, a method for forming a device housing with curved side surfaces that blend into a flat back surface is described. The method includes receiving a device housing material, and machining the curved side surfaces along a periphery of the device housing material using an obtuse profile cutter. The obtuse profile cutter includes a curved section and a straight angled portion adjacent the curved section having a transition angle configured to provide a transition from the curved side surfaces to the flat back surface.

According to yet another embodiment, an obtuse profile cutter for forming a curved side surface in a housing and an angled transition surface for blending into a flat back surface of the housing is described herein. The obtuse profile cutter includes a curved section configured to create the curved side surfaces, and a straight angled portion adjacent the curved section and configured to provide the angled transition surface.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The described embodiments may be better understood by reference to the following description and the accompanying drawings. Additionally, advantages of the described embodiments may be better understood by reference to the following description and accompanying drawings. These drawings do not limit any changes in form and detail that may be made to the described embodiments. Any such changes do not depart from the spirit and scope of the described embodiments.

FIG. 1A shows a cross-sectional view of a process for machining a curved surface of a device housing.

FIG. 1B shows a cross-sectional view of a process for machining a flat surface of a device housing.

FIG. 1C shows a cross-sectional view of a process for polishing a step created at the intersection of a curved surface and a flat surface.

FIG. 2 shows a cross-sectional view of a process for machining a curved surface using an obtuse profile cutter, according to an embodiment of the invention.

FIG. 3 shows a cross sectional view illustrating how intersection points between a curved surface and a flat surface can vary based on tolerances, according to an embodiment of the invention.

FIG. 4 shows a plan view of a device housing being machined by an obtuse profile cutter, according to an embodiment of the invention.

FIG. 5 shows a polishing process that can be used to remove shallow peaks formed from using an obtuse profile cutter, according to an embodiment of the invention.

FIG. 6 shows a flow chart detailing a process for creating a smooth transition between a curved surface and a flat surface using an obtuse profile cutter, according to an embodiment of the invention.

FIG. 7 shows a flow chart detailing a process for creating a smooth transition between a curved surface and a flat surface using an obtuse profile cutter, according to an embodiment of the invention.

### DETAILED DESCRIPTION OF SELECTED EMBODIMENTS

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

Device housings including flat surfaces and rounded edges are often machined using multiple cutters. For example, a profile cutter can be used around the periphery of the device to create the curved side surfaces of the housing while a different cutter such as a fly cutter can be used to machine the flat surfaces. Tolerances and imperfections can lead to steps between the surfaces created using different cutters, and often these steps can be visible to a user of the device. A method is disclosed that prevents the formation of steps and allows for a smooth transition between flat and curved surfaces by using a profile cutter with an obtuse angle. The profile cutter can extend into the area in which the flat surface is desired while angling upwards and away from the part. This angle can ensure that the boundary between the flat surfaces and curved surfaces forms a shallow peak rather than a step. A shallow peak can be relatively easier to blend during a polishing operation than a step. As a result, the boundaries between surfaces can be hidden from the user of the device and the manufacturing process can be more efficient.

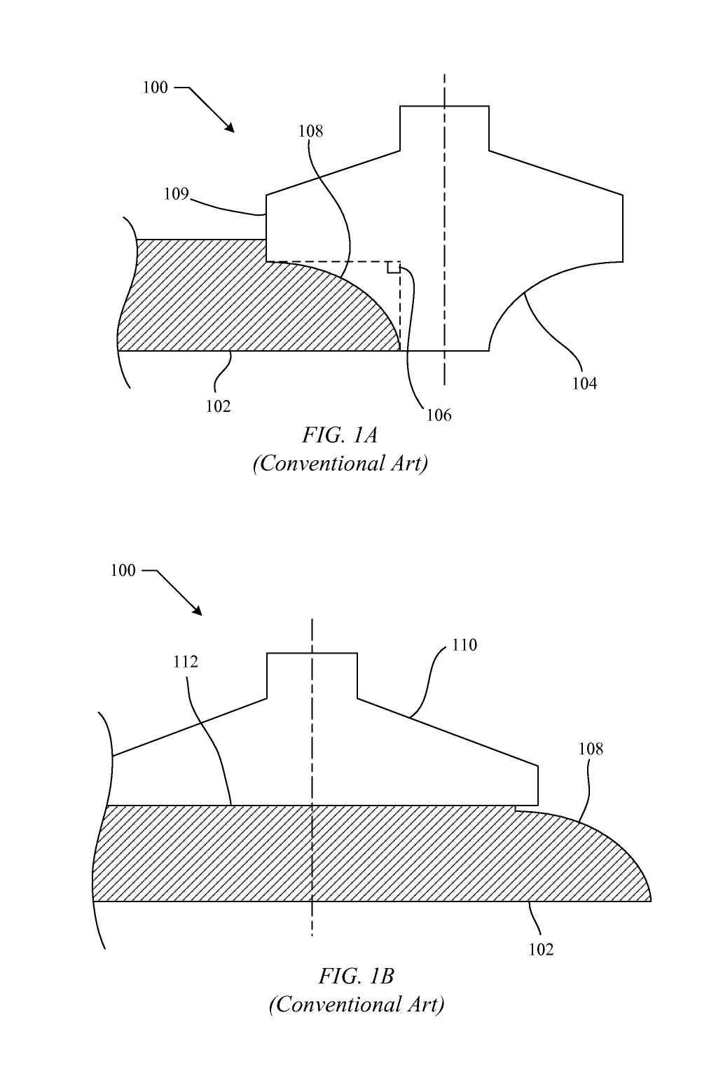

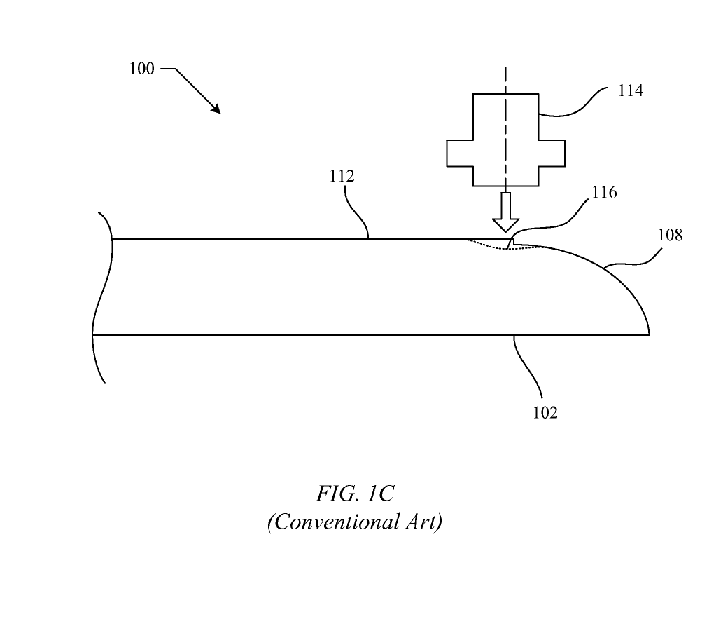

FIG. 1A shows a method 100 for performing a first cutting operation when forming device housing 102. Conventional profile cutter 104 can be used around a periphery of housing 102 to form curved surface 108. Conventional profile cutter 106 can have a curved cutting portion that forms right angle 106. Furthermore, surface 109 can cut an approximately vertical surface at an edge of curved surface 108. FIG. 1B shows a second cutting operation involved in forming device housing 102 through method 100. A cutter configured to produce uniform flat surface can be used to machine flat surface 112 of device housing 102. Cutter 110 can represent a large fly cutter designed to form surface 112 in a single pass or a smaller cutter configured to form surface 112 in multiple passes. Due to imperfections in the material from which housing 102 is formed and tolerances in the machining process, a step can be created between flat surface 112 and curved surface 108 during conventional method 100.

FIG. 1C shows a final step for method 100 in which the step between flat surface 112 and curved surface 108 is removed using a polishing process. Polishing bit 114 can be positioned above the step in housing 102 and lowered to remove the step. However, achieving the correct pressure and position to blend curved surface 108 into flat surface 112 can be difficult in a high volume manufacturing environment. Often, too much pressure can be applied or the polishing can take place in too large of an area. As a result, shallow groove 116 can form during the polishing process. This groove can be visible to the user of the device, particularly when illuminated at an angle that casts the groove into a shadow. This can remove the appearance that the housing is formed from a single, continuous surface, negatively impacting the experience of the user of the device.

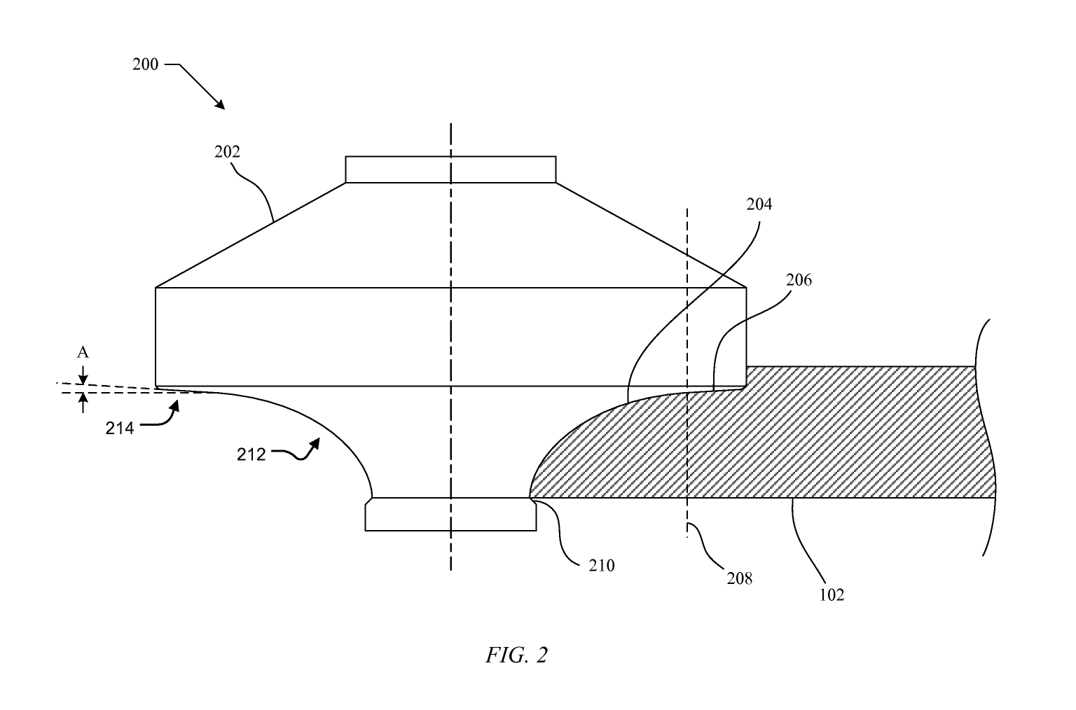

FIG. 2 shows process 200, illustrating a method for forming curved surface 204 along a periphery of housing 102 while avoiding the step that was shown in process 100. Obtuse profile cutter 202 can include a curved portion 212 configured to cut curved surface 204 and a straight angled portion 214 adjacent the curved portion 212 and configured to cut surface 206. Line 208 can represent the nominal boundary between curved surface 204 and a flat surface to be created in a subsequent cutting operation. Angled surface 206 can extend into the area in which the flat surface will be cut while angling upwards at a transition angle A. The value of angle A can depend on the level of precision needed in a particular application and the tolerances associated with a milling machine spinning obtuse profile cutter 202. In one embodiment, an angle A of approximately and/or about 1 degree can be sufficient to blend a curved surface and a flat surface. However, smaller values for angle A can be appropriate when less polishing is desired and higher values for angle A are available when more polishing is available or less blending is required. Therefore, according to some embodiments, the angle A may be greater than about 1 degree or less than about 1 degree, depending upon desired surface characteristics.

Obtuse profile cutter 202 can be made from a variety of materials including carbide, cobalt alloys, steel, carbon, and any other robust material capable of withstanding a cutting operation. According to at least one embodiment, the obtuse profile cutter is formed of a material comprising at least one of carbide, cobalt alloy, steel, and ceramic. Similarly, housing 102 can be machined from many different materials. For example, housing 102 can be composed of metal, plastics, composites, wood, aluminum, or any other technically feasible material. In one embodiment, obtuse profile cutter 202 can also include angled surface 210 aligned with a bottom edge of housing 102 adjacent a distal end of the obtuse profile cutter 202. Angled surface 210 can reduce an amount of burrs that form along an outer corner of housing 102 during the machining process. This can be particularly advantageous when housing 102 must lie flat in a subsequent manufacturing process.

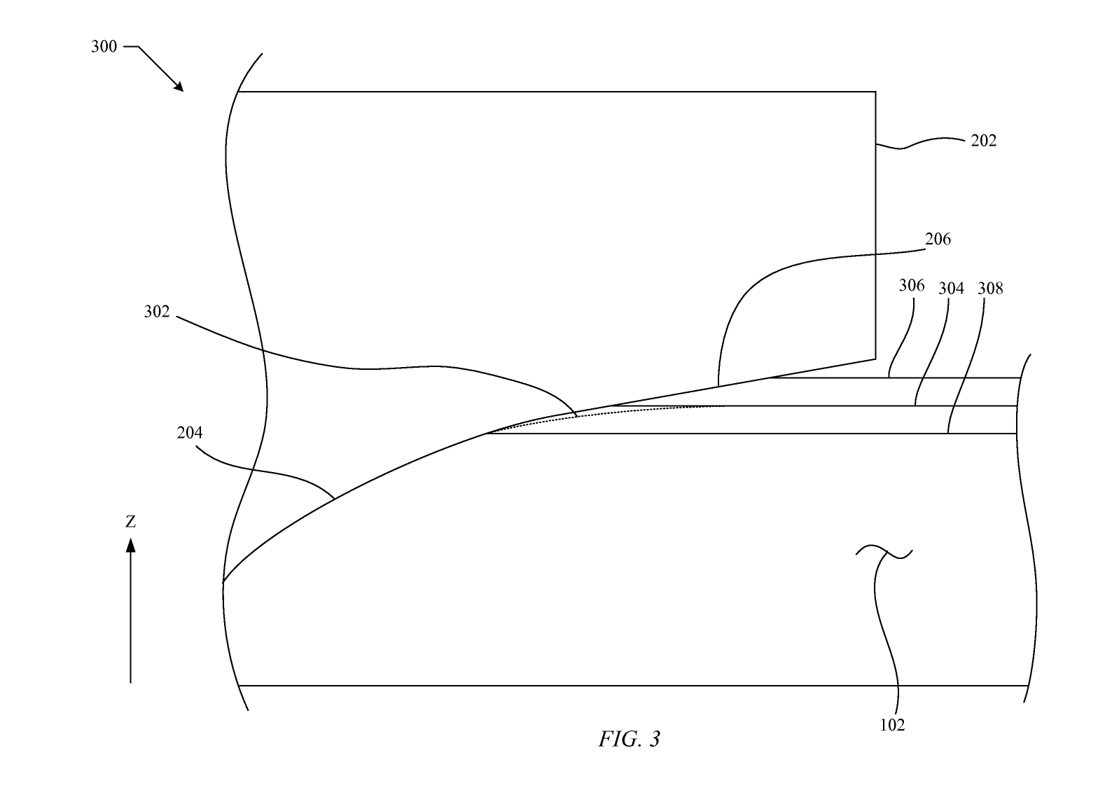

FIG. 3 demonstrates process 300, illustrating how variations in the flat surface can be accommodated by curved surface 204. The Z direction in FIG. 3 is exaggerated to better illustrate the effect. Housing 102 is shown including curved surface 204. An edge of obtuse profile cutter 202 is shown for reference. After the periphery of housing 102 is formed using obtuse profile cutter 202, the flat surface can be cut using methods similar to those described in process 100 and shown in FIG. 1B. Surface 304 represents the nominal location for the flat surface and line 302 represents the design profile shape for housing 102. Surface 306 represents an upper allowable tolerance for the flat surface and surface 308 represents a lower allowable tolerance for the flat surface. If the flat surface is formed at nominal surface 304, then a shallow peak can be formed around the periphery of housing 102 at the intersection of nominal surface 304 and curved surface 204. Similarly if the flat surface is formed at the upper tolerance level or the lower tolerance level, then a shallow peak can be formed at the intersection of curved surface 204 and surfaces 306 and 308 respectively.

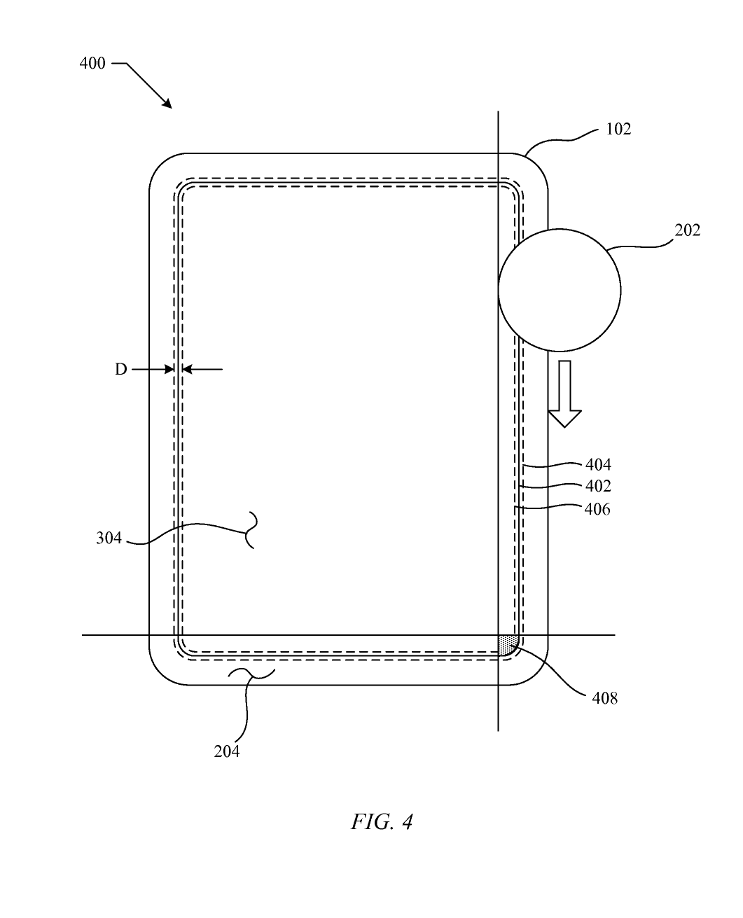

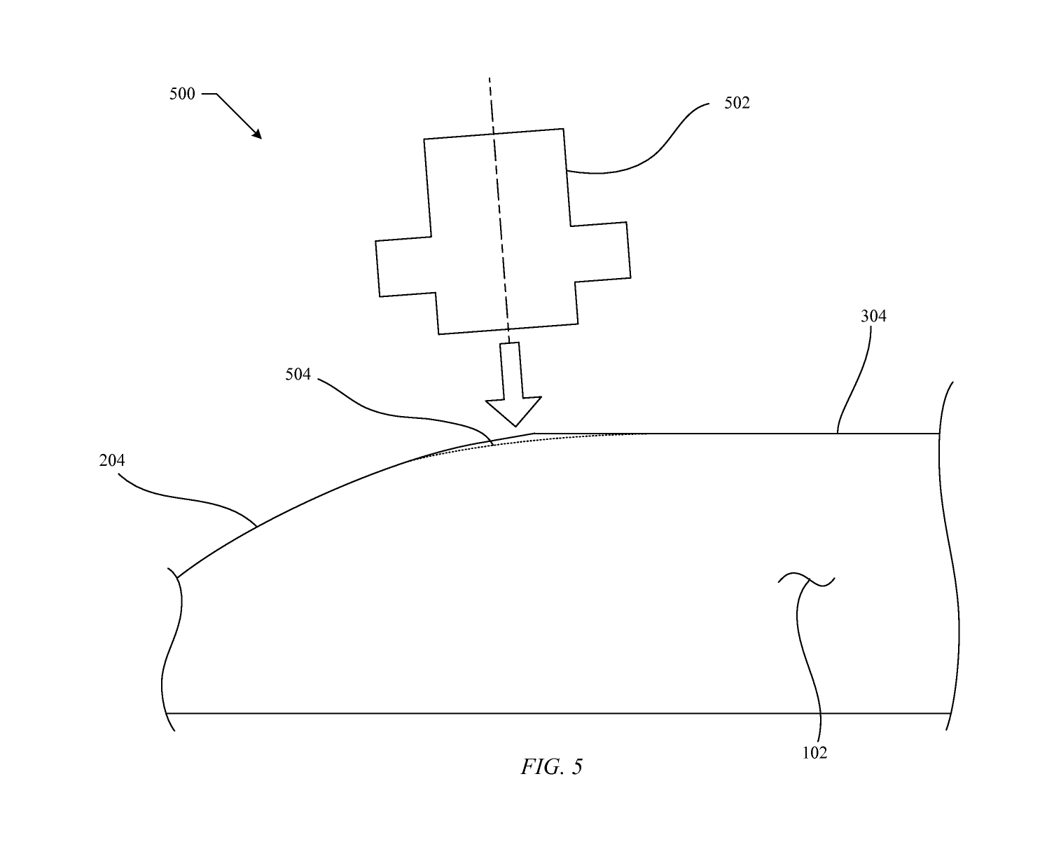

FIG. 4 shows a plan view of housing 102 further demonstrating the intersection between curved surface 204 and flat surface 304. Line 402 represents the shallow peak formed between curved surface 204 and flat surface 304 when flat surface 304 is machined in the nominal location. Dashed lines 404 and 406 show the location of the shallow peak when flat surface 304 is located at the lowest and highest allowable positions respectively. Thus, the shallow peak can be limited to an area between dashed lines 404 and 406. The distance D between dashed lines 404 and 406 can depend on angle A and tolerances associated with the particular manufacturing process. In one embodiment, distance D can be as small as 50 microns when using an angle A of approximately 1 degree and typical computer numerical control (CNC) milling machine tolerances. Any polishing processes that are needed to eliminate the shallow peak formed at the intersection of curved surface 204 and flat surface 304 can then be limited to the small area between dashed lines 404 and 406.

Obtuse profile cutter 202 can also offer advantages when machining around corners of a device. Region 408 represents an area of housing 102 in which a conventional profile cutter, such as profile cutter 104 shown in FIG. 1A, would pass over the same area for a relatively long amount of time and from different angles. When this occurs, the material being cut can be compressed and moved from one location to another instead of being properly cut. This can lead to deformations that can result in defects or additional sanding and polishing processes that can add time and expense to the manufacturing process. These problems can be avoided by using obtuse profile cutter 202. The angle of obtuse profile cutter 202 prevents the cutter from passing over any area more than once as the cutter goes around cutters. This can reduce defects and finishing processes, improving the efficiency of the manufacturing process.

FIG. 5 illustrates process 500 for polishing housing 102 following a machining process. When curved surface 204 is formed using obtuse profile cutter 202, a shallow peak can form at the intersection of curved surface 204 and flat surface 304. This peak can deviate from line 504, which represents the design shape for housing 102. The peak can be reduced to line 504 using polishing tool 503. Polishing tool 503 can include an abrasive pad mounted to a rotating mill. The mill can direct the polishing pad around the periphery of housing 102 in the area in which the shallow peak exists. Unlike polishing the step shown in FIG. 1C, polishing a shallow peak can be less likely to result in a groove. Thus, the polishing process can smoothly blend curved surface 204 into flat surface 304, forming an unbroken surface with no boundaries visible to the user.

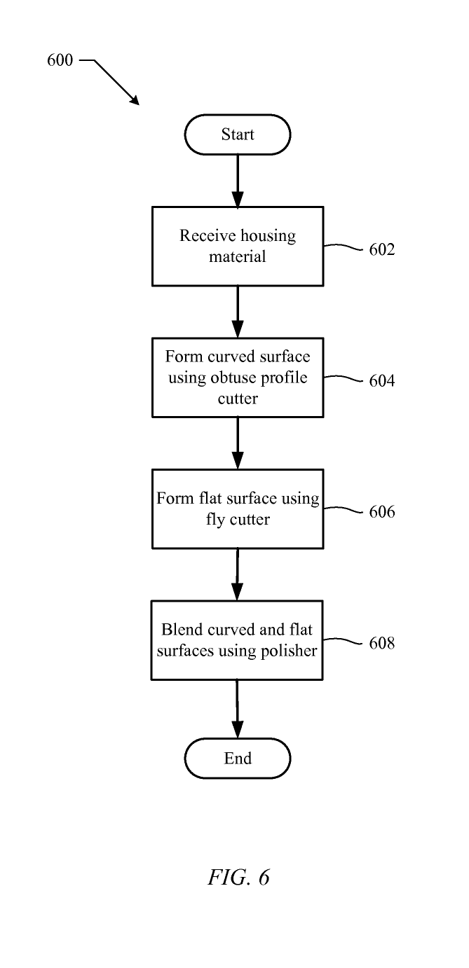

FIG. 6 shows flowchart 600, describing a method of implementing the described embodiments. In step 602, housing material is received. The housing material can include any material capable of being machined in a typical milling process. For example, acceptable materials can include metal, plastics, composites, wood, or any other technically feasible material. It can be advantageous if the housing material is received in a shape that is only slightly larger than the shape of the finished product as this can reduce machining time and wasted material.

In step 604, a curved surface can be formed along a periphery of the housing material using an obtuse profile cutter. The obtuse profile cutter can be attached to a milling machine. In one embodiment, the milling machine can be controlled by a computer numerical control (CNC) machine to add precision and uniformity to the process. The obtuse profile cutter can include a curved section and an angled section, where the angled section is angled upwards and designed to intersect with a flat surface formed in a later step. In step 606, a fly cutter or flat tipped milling bit can be used to machine the flat surface of the housing. The flat surface can be formed in a single pass or formed from multiple passes made by a smaller cutter. In another embodiment, steps 604 and 606 can be reversed so that the flat surface is machined prior to the curved surface.

Finally, in step 608, the shallow peak that can be formed at the intersection of the curved surface and the flat surface can be ground away using a polishing process. The polishing process can be performed by the same milling machine that cut the curved and flat surfaces or performed in a later manufacturing process. After the polishing process, the curved surface smoothly blends into the flat surface, preventing a user of the device from discerning where one surface begins and another ends.

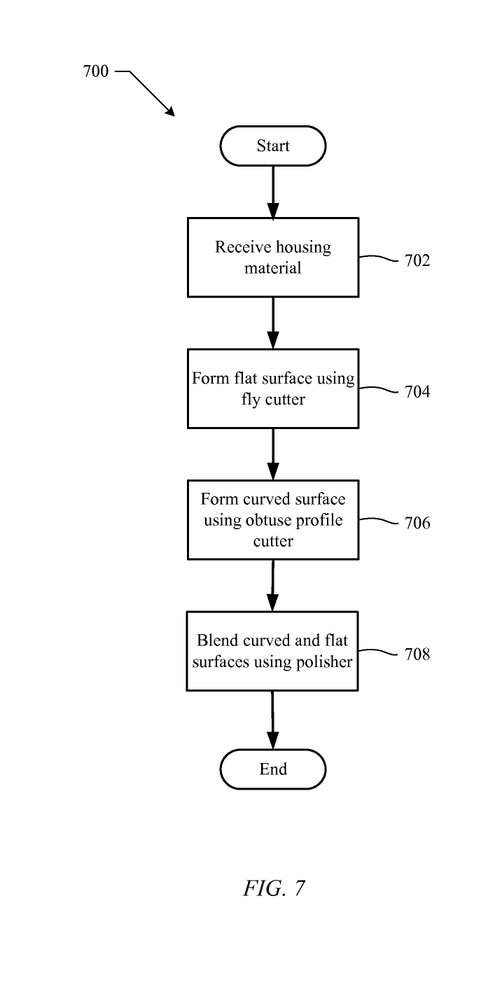

Although described with reference to FIG. 6 as a having a flat surface formed subsequent to a curved surface, the same may be varied in many ways. For example, FIG. 7 shows flowchart 700, describing an alternate method of implementing the described embodiments. In step 702, housing material is received. The housing material can include any material capable of being machined in a typical milling process. For example, acceptable materials can include metal, plastics, composites, wood, or any other technically feasible material. It can be advantageous if the housing material is received in a shape that is only slightly larger than the shape of the finished product as this can reduce machining time and wasted material.

In step 704, a fly cutter or flat tipped milling bit can be used to machine the flat surface of the housing. The flat surface can be formed in a single pass or formed from multiple passes made by a smaller cutter. In step 706, a curved surface can be formed along a periphery of the housing material using an obtuse profile cutter. The obtuse profile cutter can be attached to a milling machine. In one embodiment, the milling machine can be controlled by a computer numerical control (CNC) machine to add precision and uniformity to the process. The obtuse profile cutter can include a curved section and an angled section, where the angled section is angled upwards and designed to intersect with the formed flat surface.

Finally, in step 708, the shallow peak that can be formed at the intersection of the flat surface and the subsequently formed curved surface can be ground away using a polishing process. The polishing process can be performed by the same milling machine that cut the curved and flat surfaces or performed in a later manufacturing process. After the polishing process, the curved surface smoothly blends into the flat surface, preventing a user of the device from discerning where one surface begins and another ends.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for forming a device housing with curved side surfaces that blend into a flat back surface, the method comprising:
receiving a device housing material; and
machining the curved side surfaces along a periphery of the device housing material using an obtuse profile cutter, wherein the obtuse profile cutter includes a curved section configured to create the curved side surfaces and a straight angled portion configured to provide a transition from the curved side surfaces to the flat back surface.

2. The method of claim 1, further comprising machining the flat back surface.

3. The method of claim 2, further comprising performing a polishing process on the intersection between the curved side surface and the flat back surface, wherein the polishing process removes any peaks and provides a seamless transition between the curved side surfaces and the flat back surface.

4. The method of claim 1, wherein the obtuse profile cutter is formed of a material comprising at least one of carbide, cobalt alloy, steel, and ceramic.

5. The method of claim 1, wherein the device housing is formed of a material comprising at least one of metal, plastic, composite material, wood, and aluminum.

6. The method of claim 1, wherein machining the curved side surfaces comprises:
machining the curved side surfaces using a computer numerical control (CNC) machining process.

7. The method of claim 1, wherein the straight angled portion includes a transition angle of about one degree.

8. The method of claim 1, wherein the straight angled portion includes a transition angle of less than about one degree.

9. The method of claim 1, wherein the straight angled portion includes a transition angle of more than about one degree.

10. The method of claim 1, wherein the obtuse profile cutter further comprises an angled surface aligned with a bottom edge of housing and configured to reduce an amount of burrs along an outer corner of housing during machining

11. A method for forming a device housing with curved side surfaces that blend into a flat back surface, the method comprising:
receiving a device housing material;
machining the curved side surfaces along a periphery of the device housing material using an obtuse profile cutter, wherein the obtuse profile cutter includes a curved section and a straight angled portion adjacent the curved section having a transition angle configured to provide a transition from the curved side surfaces to the flat back surface.

12. The method of claim 11, further comprising machining the flat back surface.

13. The method of claim 12, further comprising performing a polishing process on an intersection between the curved side surface and the flat back surface.

14. The method of claim 12, wherein machining the flat back surface is subsequent to machining the curved side surfaces.

15. The method of claim 12, wherein the curved side surfaces is subsequent to machining the flat back surface.

16. The method of claim 11, wherein the obtuse profile cutter is formed of a material comprising at least one of carbide, cobalt alloy, steel, and ceramic.

17. The method of claim 11, wherein the device housing is formed of a material comprising at least one of metal, plastic, composite material, wood, and aluminum.

18. The method of claim 1, wherein machining the curved side surfaces comprises:
machining the curved side surfaces using a computer numerical control (CNC) machining process.

19. The method of claim 11, wherein the transition angle is about one degree.

20. The method of claim 11, wherein the obtuse profile cutter further comprises an angled surface proximate a distal end of the obtuse profile cutter and adjacent the curved section configured to reduce an amount of burrs along an outer corner of housing during machining

21. An obtuse profile cutter for forming a curved side surface in a housing and an angled transition surface for blending into a flat back surface of the housing, comprising:
a curved section configured to create the curved side surfaces; and
a straight angled portion adjacent the curved section and configured to provide the angled transition surface.

22. The obtuse profile cutter of claim 21, wherein the obtuse profile cutter is configured to be used with a computer numerical control (CNC) machine in a machining process.

23. The obtuse profile cutter of claim 21, wherein the straight angled portion includes a transition angle of about one degree.
